(19) United States
(12) Patent Application Publication
(10) Pub. No.: US 2012/0159427 A1
(43) Pub. Date: Jun. 21, 2012

(54) SYSTEM AND METHOD FOR EXTRACTING UML MODELS FROM LEGACY APPLICATIONS

(75) Inventors: Ioan Mihai Oara, Cary, NC (US); Alexander Alprelev, Cary, NC (US)

(73) Assignee: Micro Focus (US), Inc., Rockville, MD (US)

(21) Appl. No.: 13/298,268

(22) Filed: Nov. 16, 2011

Related U.S. Application Data
(63) Continuation of application No. 11/649,134, filed on Jan. 3, 2007, now abandoned.

(51) Int. Cl. G06F 9/44

(52) U.S. Cl. 717/104

(57) ABSTRACT

A method and computer program product are provided for extracting UML models from legacy applications. The system involves extraction of UML models and importing and exporting than to other commercial UML tools. In a more specific aspect, UML objects are associated with business rules which have been extracted from a legacy application. In particular, UML diagrams are extracted from a legacy application for Use Case diagrams, Activity diagrams from screen flows, and Activity diagrams from program logic.

### CROSS-REFERENCE TO RELATED APPLICATIONS

This application is a continuation of U.S. patent application Ser. No. 11/649,134, filed on Jan. 3, 2007 (Attorney Docket No.: MIC-149), entitled “System and Method for Extracting UML Models from Legacy Applications,” which is hereby incorporated by reference in its entirety for all purposes.

### FIELD

This invention relates to a computer program product and method for extracting UML models from legacy applications. More specifically, the invention relates to a method and product for extracting and enhancing a UML model from a legacy application, based on an existing repository containing all necessary information about the legacy application.

### BACKGROUND

In modern application development, it is desirable to capture the requirements, functionality and implementation details of an application in the form of design models. One such design model, which is commonly used, is known as the Unified Modeling Language, i.e., UML, which provides a standard which allows for the use of a variety of commercial tools to allow communication between parties.

For purposes of this description, it is noted that the Unified Modeling Language (UML) is a well-known nonproprietary, object modeling and specification language used in software engineering. UML is a general purpose modeling language that includes a standardized graphical notation that may be used to create an abstract model of a system which is typically known as the UML model.

In modern application development, UML is primarily used for developing new applications. However, up to now, UML tools have not been used to describe what are known generally as legacy applications which have been designed and built with older technologies.

Using UML is desirable for new or more modem applications for a number of reasons. First, UML is generally accepted as a language, and any UML description of an application is easy to share between development teams. There are also many commercially available software tools which are capable of forward engineering UML models into program code, all done in a conventional manner as will be readily apparent to those of ordinary skill in the art. Modem day UML tools such as Rational Rose, Together, Sparx, etc. are useful for reverse engineering applications by extracting UML from code in modem languages like Java. However, there are no such tools offering the same reverse engineering capability for use with legacy applications.

By the term legacy applications is meant applications developed with technologies beginning in the 1960s to date. Such legacy applications have been written in languages such as COBOL, PLI, Natural and RPG. Such applications also include databases such as VSAM, ADABAS, IMSIDB, IDMS, and DMS. Other legacy applications include environments such as CICS, IMSIDC. Most of such applications were developed prior to the development of UML.

Accordingly, although not completely useful when employed with legacy applications because of the design of current UML tools for use with modem applications, the problems of the use of existing UML tools with older applications is overcome in accordance with the invention in which there is provided a method and system of using UML tools to generate a UML diagram for legacy applications

### BRIEF DESCRIPTION OF THE INVENTION

Accordingly, in accordance with the invention there is provided a method of extracting UML models from a legacy application. It is assumed that there has already been created a repository of all objects and information about the objects contained in the legacy application. It is also assumed that the repository also contains a collection of business rules implemented in the application. For each legacy application object and for each business rule, the repository keeps pointers to the legacy artifacts or code where they are implemented (such as programs, screens, tables or transactions). Such repositories describing legacy applications may be created using existing legacy analysis commercial tools, as for instance Relativity Modernization Workbench. It is further assumed that the repository is accessible to the system described by this invention through a specialized library of programs, usually called an API (“application public interface”). This interface would allow the system described by the invention to access facts about the legacy application, in particular the association between screens and programs and the transitions or calls between the programs. Such information may be used to create the so-called “screen flows,” which indicate the order in which the screens are navigated by the application user in order to perform a particular task. Once a UML diagram describing the legacy application is created by processing the repository, UML objects in the UML diagram are linked either automatically or manually to the legacy objects and in particular to the business rules which have been extracted from the legacy application, thus creating an enhanced UML model.

In a more specific aspect, this invention involves the creation of two types of UML diagrams: Use Case diagrams and Activity diagrams. For purposes of describing the invention, the following definitions are provided.

Activity diagram: Activity diagrams are diagrams are used to model the behaviors of a system and the way in which the behaviors are related in an overall flow of the system. Activity diagrams show the logical paths a process follows based on various conditions, concurrent processing, data access, interruptions and other logical path distinctions which are all used to construct a process, system or procedure.

Activity: An activity organizes and specifies the participation of subordinate behavior's, such as sub-activities or actions, to retlect the control and data flow of a process. Activities are used for a number of modeling purposes, from procedural-type application development for system design, to business process modeling of organizational structures or workflow.

Use Case diagram: A Use Case diagram captures use cases and actor interactions. It describes the functional requirements of a system, the manner that outside things (actors) interact at the system boundary, and the response of the system.

Use Case: A Use Case is a UML modeling element that describes how a user of the proposed system will interact with the system to perform a discreet unit of work. It describes and signifies a single interaction over time that has meaning for the end user (person, machine, or other system), and is required to leave the system in a complete state, either with the interaction completed or rolled back to its initial state.

Business Rule: Business rules describe the operations, definitions and constraints that apply to an organization in achieving its goals. They mey be implemented in the code of a computer application serving the organization. In the case of an existing legacy application, business rules may be collected. One example of how such business rules may be collected is described in U.S. patent application Ser. No. 10/827,953, the disclosure of which is incorporated by reference in its entirety.

In a yet more specific aspect, method involves creating Use Case diagrams from a hierarchy of screens of the legacy application. An Activity diagram is created based on a flow of screens and procedures of the legacy application.

In the case of the hierarchy of screens, it comprises a tree format starting with the main menu screen and subsequent flows to other screens. The Use Cases are designated by pointing to selected screens and creating a Use Case for each selected screen in a manner in which, if a selected screen is subordinate to another selected screen, then its Use Case either extends or is included in the Use Case derived from the screen to which it is subordinate.

Yet still further the UML diagrams and UML objects from the legacy application can be manually modified to describe additional information not automatically extracted with the UML mining tool. In a yet still a more specific aspect, the UML diagrams and objects are created in a manner in which they can be exported to and imported from another UML tool through XMI. The enhanced UML model results in part from attaching business rules extracted from the legacy program to the UML model created with the UML mining tool to result in the enhanced model.

In a yet still further aspect, the invention relates to a computer program product configured for achieving the foregoing. The product is encoded on storage media such as CD, hard drive, USB flash drive, etc. and others as will be readily apparent to those of ordinary skill. It is operable on a computer with screens and other peripherals, as will be readily apparent to those of ordinary skill.

The program is designed for accessing a repository of all objects and information about the objects which are contained in a legacy application. The program functions to create a UML model of the legacy application by processing the repository. A further function allows linking of UML objects in the UML model to business rules and specifying of additional details about the UML objects, including at least information about the legacy objects and where they were derived.

### BRIEF DESCRIPTION OF THE DRAWINGS

Having thus briefly described the invention, the same will become more clearly evident from the following detailed discussion of the drawing wherein:

FIG. 1 is a general flow diagram of a how a refined or enhanced UML model is created from a legacy application, such as an application written in COBOL or other like language; and

FIG. 2 is a flow diagram in simplified step form of how a diagram representing legacy artifacts can be first adjusted to show the relevant aspects, then a UML diagram is extracted and finally the UML diagram is improved by adding additional specifications.

FIG. 3 is a screen shot illustrating how a user gives significant business names to all screens;

FIG. 4 is a screen shot illustrating how the user may click on a screen item in the screen flow diagram and view the layout of the screen;

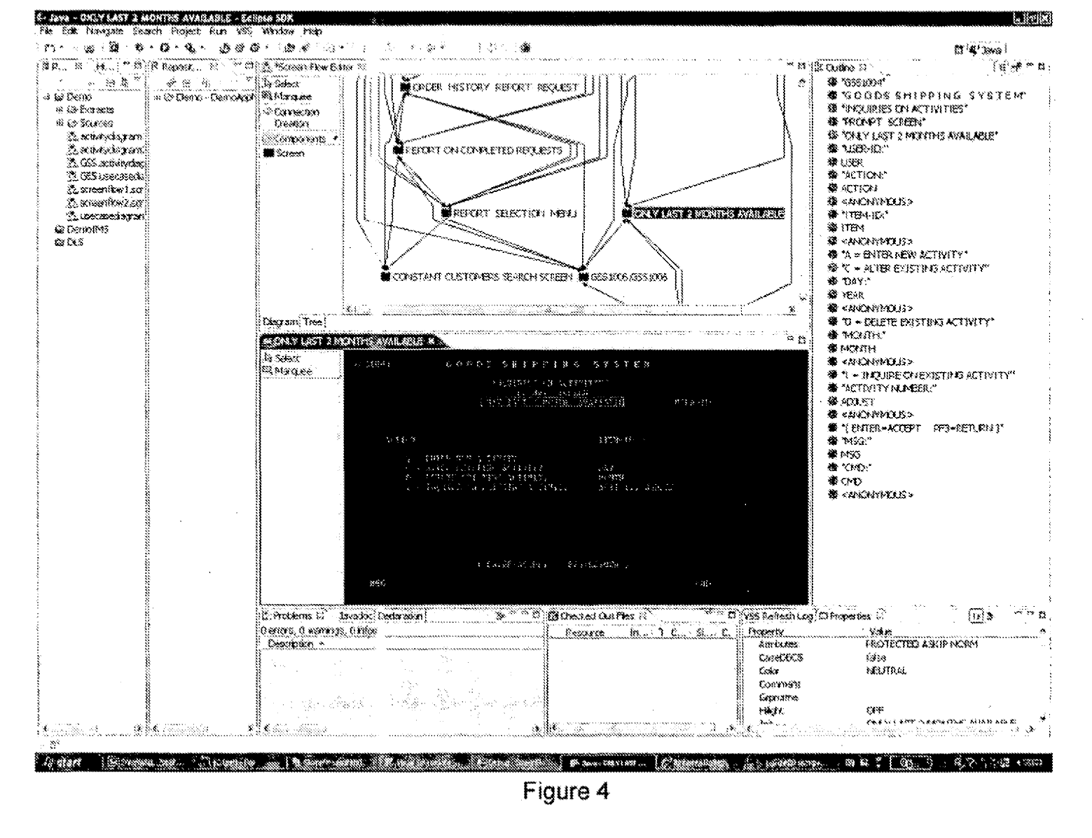

FIG. 5 is a screen shot illustrating how an empty Activity diagram is first created, then a screen event is selected for the purpose of designating it as an activity;

FIG. 6 is a screen shot illustrating how a Use Case diagram is first created as an empty diagram;

FIG. 7 is a screen shot illustrating how a Use Case is saved;

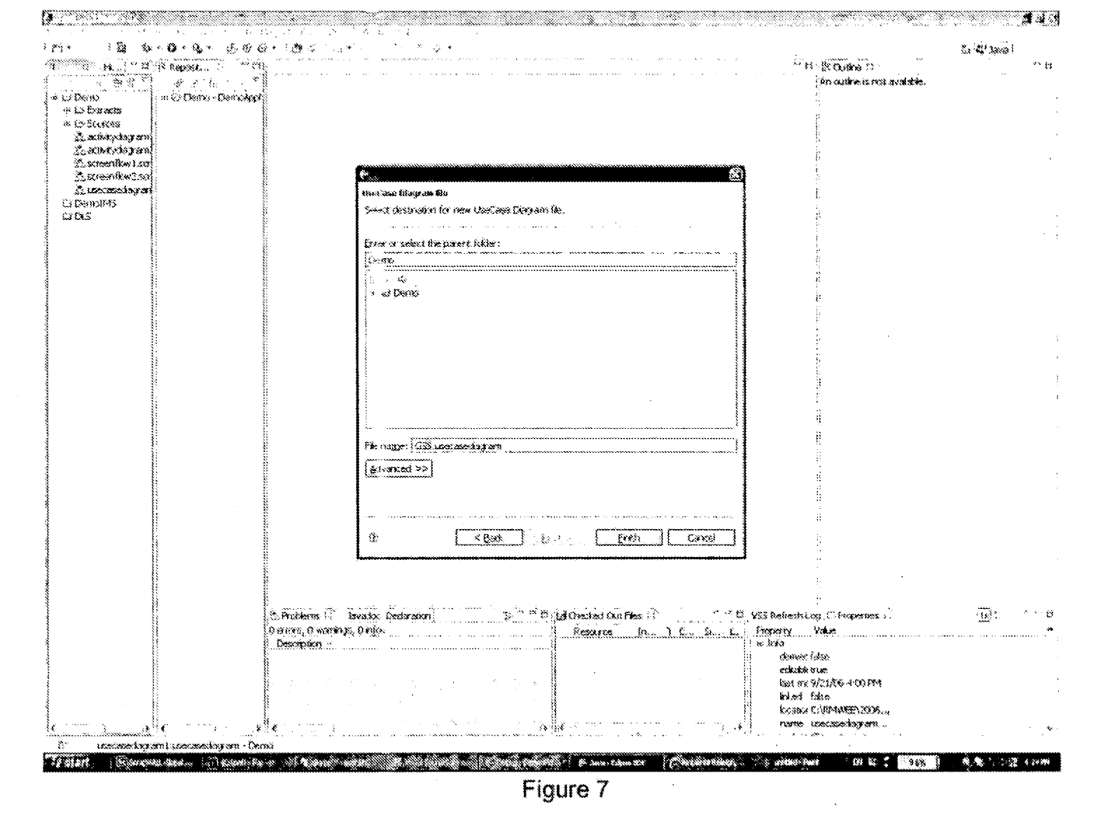

FIG. 8 is a screen shot illustrating how the user designates one of the screens of the application as the “root screen,” which is the one from Which the user of the application enters the application.

FIG. 9 is a screen shot illustrating how the tree of screens is reorganized with the “root screen” as the root of the tree of screens, as the result of the action on FIG. 8.

FIG. 10 is a screen shot illustrating how a Use Case is created in a Use Case diagram, after the user drags a screen icon from the screen flow diagram into the Use Case diagram.

FIG. 11 is a screen shot illustrating how when screens are dragged and dropped from the screen navigation tree into a Use Case diagram, the resulting Use Cases appear in the same relation of subordination as the screens.

FIG. 12 is a screen shot illustrating how a screen event is selected from the screen navigation tree to be dragged and dropped in an Activity Diagram.

FIG. 13 is a screen shot illustrating how the Activities resulting from the screen events appear in the same order as the order of the events in the screen navigation.

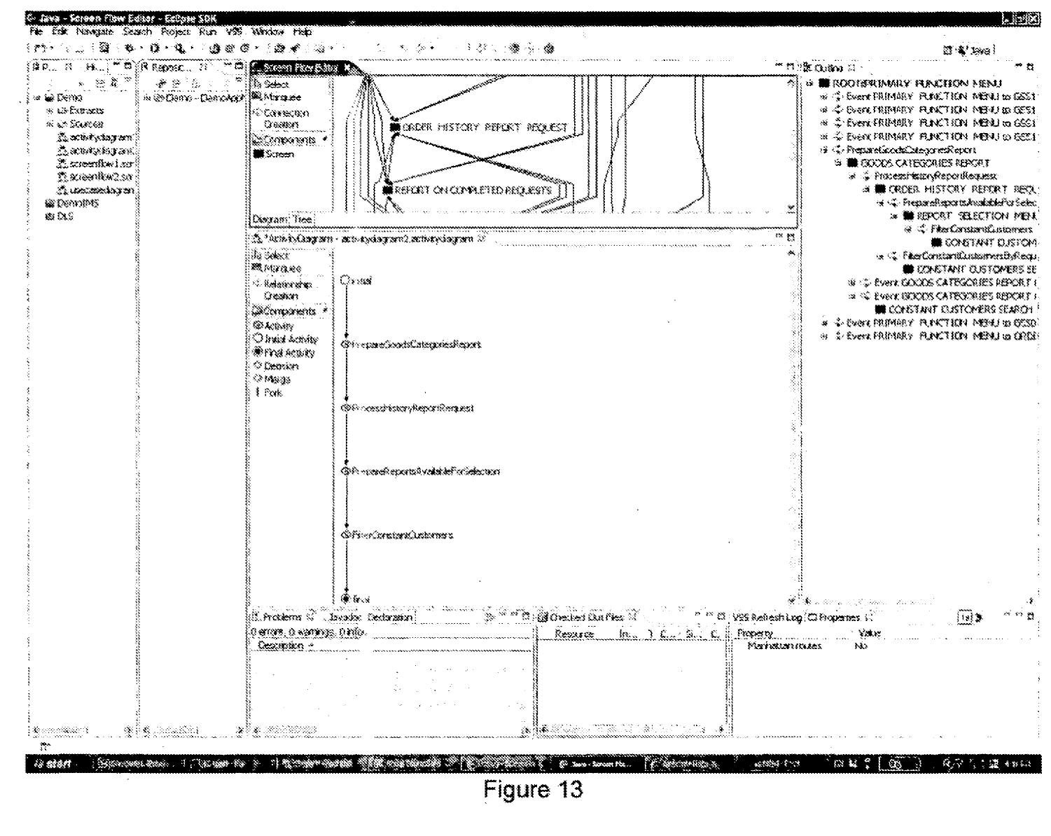

FIG. 14 is a screen shot illustrating how, when the user chooses two possible navigation paths in the screen flow diagram, a Decision object automatically appears in the Activity Diagram.

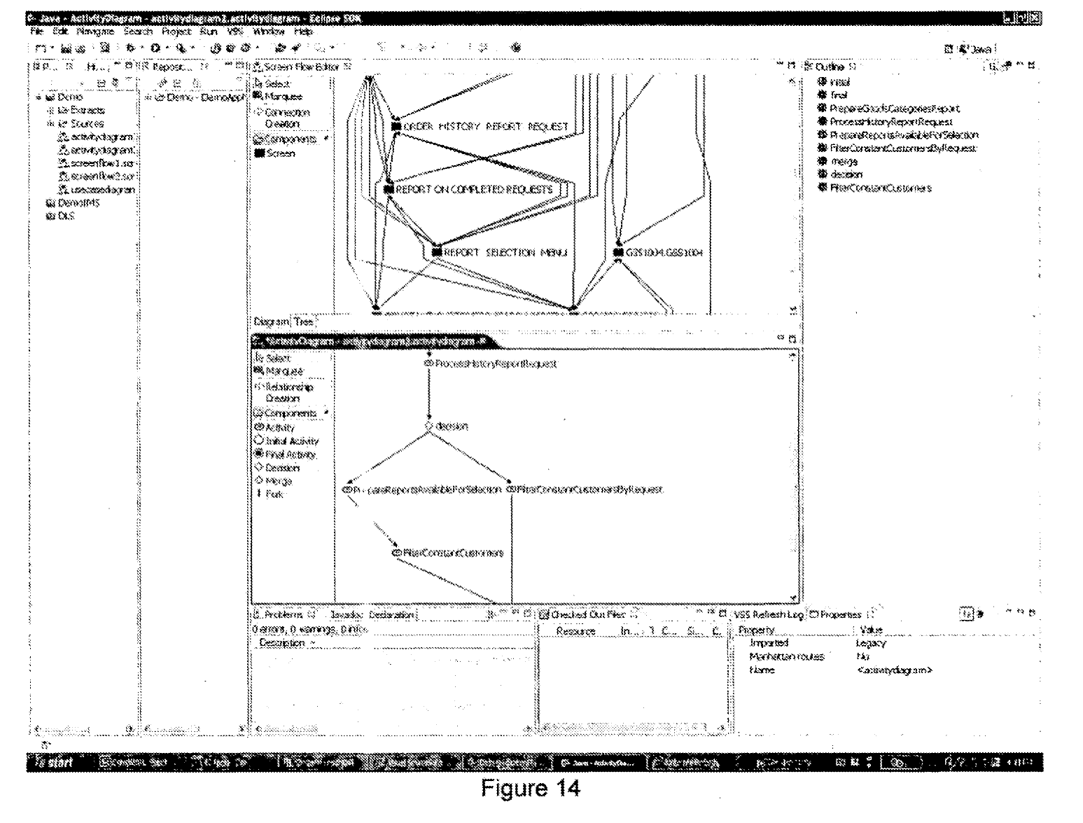

### DETAILED DESCRIPTION

In understanding the invention, it is important to appreciate that there are two major functionality aspects of high interest in analyzing a legacy application. The two functionality aspects are a UML model of the legacy application and the business rules embodied in the legacy application. With respect to extracting business rules, reference is made to copending application Ser. No. 10/827,953 filed Apr. 20, 2004 of the same inventor herein. UML, was previously discussed and is well known, and describes the requirements, functionality in terms of processes, structural aspects and implementation of the application. Business rules describe the fundamental restrictions on how the company or organization acts, irrespective of implementation.

### Example

This is an example of what kind of functionality is described in an UML model and what kind of functionality is described in business rules. A UML model may describe, for example, how to create an insurance policy by adding information about the customer and the car, in a specific number of steps. The business rules are concerned with the calculation of the premium or the criteria for accepting a particular customer.

In the past, the two aspects, i.e., UML and business rules were managed by separate technologies such as the previously described modem UML tools or business rules engines as noted with reference to the copending patent application. In accordance with the invention the two are brought together so that one analyzing an application can determine that a specific business rule is invoked during a particular process, which process is defined by the UML model. Thus, in accordance with the invention, some UML objects are able to automatically or manually be linked to business rules.

In considering how to implement the invention, it is important to understand that there may already exist a high level UML description of the application, for example, in another UML tool. In accordance with the invention, it is important to enrich the existing model by uncovering new details in the current implementation in code, or creating links for references between objects and implementation artifacts. In accordance with the invention, the UML can be extracted by the system of the invention and then exported to another UML tool, or it can also be implemented by first developing the UML model in another UML tool and then importing it into the system of the invention for later enrichment in linkage to legacy code for later reexporting. This is done, in one aspect, by a computer program product as previously described wherein the product is on storage media and functions through a computer as further described herein.

In one embodiment, a legacy repository has already been created in a manner well known to those of ordinary skill in the art. The legacy repository contains information collected by parsing the sources of a legacy application. The repository includes an inventory of all objects in the application, such as sources, programs, files, tables and screens. Information about the internals of such objects is also contained in the repository such as variable used in the program or the fields which appear on a screen.

Tools for creating such a repository are available commercially, for example, from Relativity Technologies, Inc. under the name RMW, and the invention involves in part interpreting the information in such a repository.

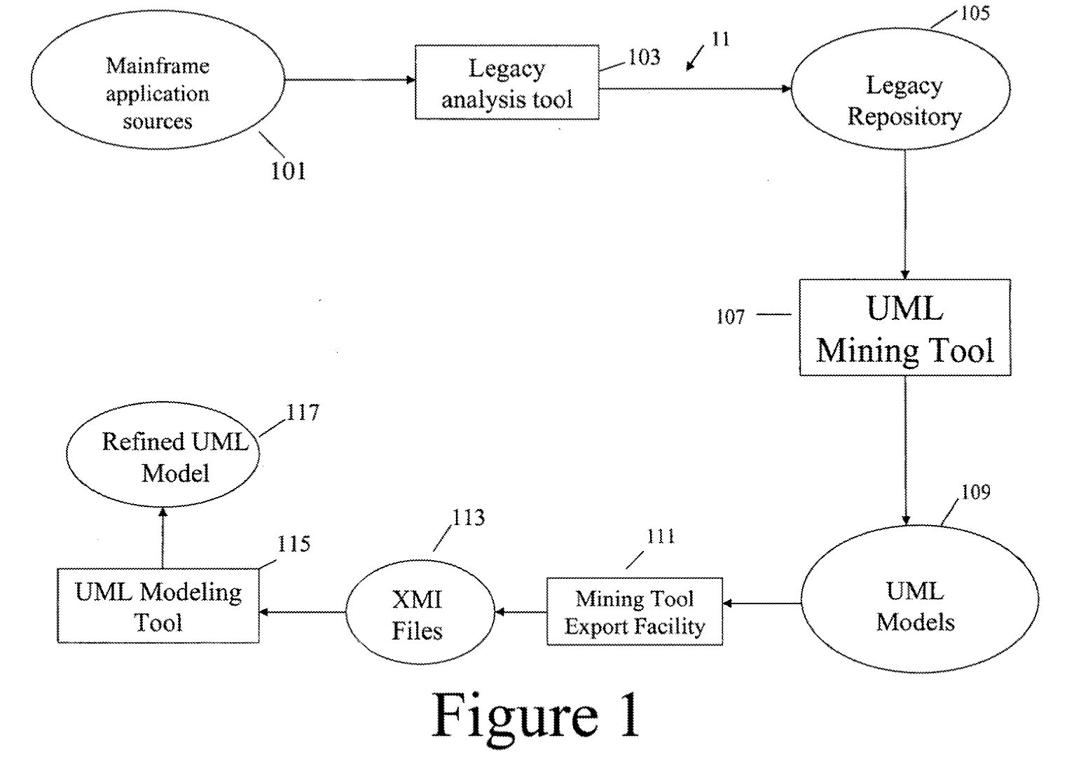

Accordingly, in a general aspect as shown FIG. 1, a mainframe legacy application 101 is analyzed with a legacy analysis tool 103 as previously described to create a legacy repository 105. Thereafter, a UML mining tool 107 is applied to the repository to create a UML model 109. As may be appreciated, while a lot of information was extracted from the legacy code, there could exist some UML specifications which could not be found in the code. An example of such a specification is the UML entity Actor which designates an external entity acting on the system. For purposes of this description, an Actor may be a person with a specific role such as a customer or another system which exchanges information with the system being analyzed. The application code in most cases does not make reference to the Actor and the user of the UML mining tool is required to identify and extract the Actor.

After a UML model is created, a mining tool export facility 111 is applied to the model to create XMI files 113 which are then processed through a UML modeling tool to result in a refined UML model 117.

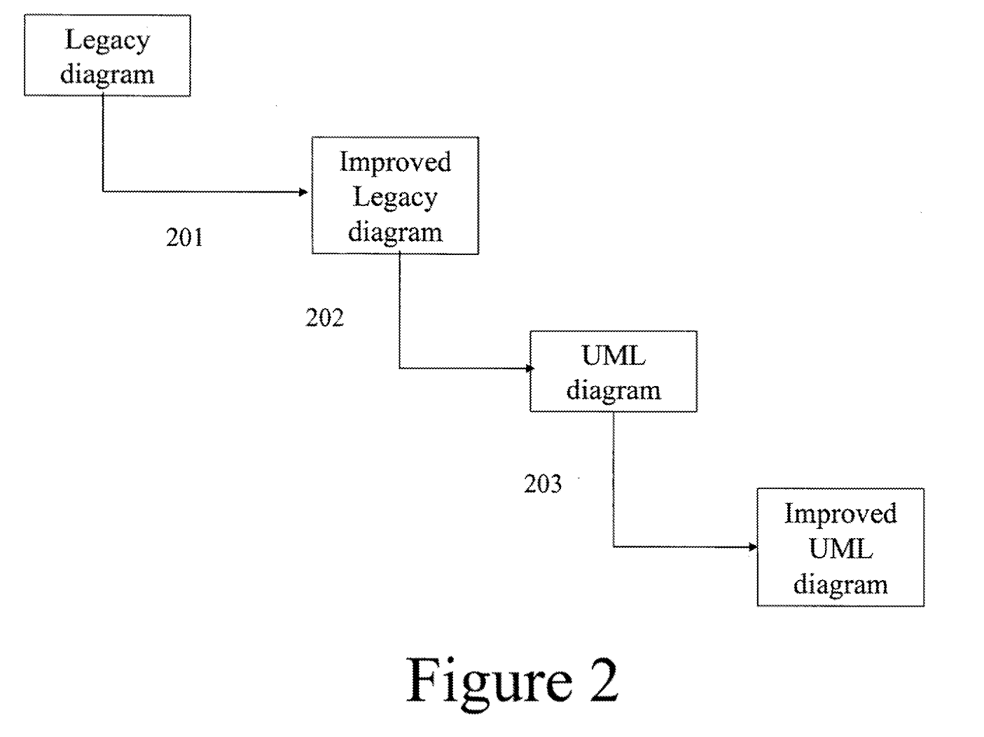

Stated more broadly as shown in FIG. 2, the invention generally involves starting with a legacy diagram 201 which is then operated on with appropriate tools to create an improved legacy diagram 202. The improvement refers to giving business names to some of the legacy artifacts or adding some additional information which was not collected by the parsing of the application. The facilities of the system are then applied to create a UML diagram 203 thereafter resulting, after additional processing as discussed hereafter, in an improved UML diagram 204.

While a number of UML diagram types may be extracted or built based on a legacy application, the invention is particularly concerned with the extraction of two types of diagrams which have been previously discussed: Use Case diagram and Activity diagram.

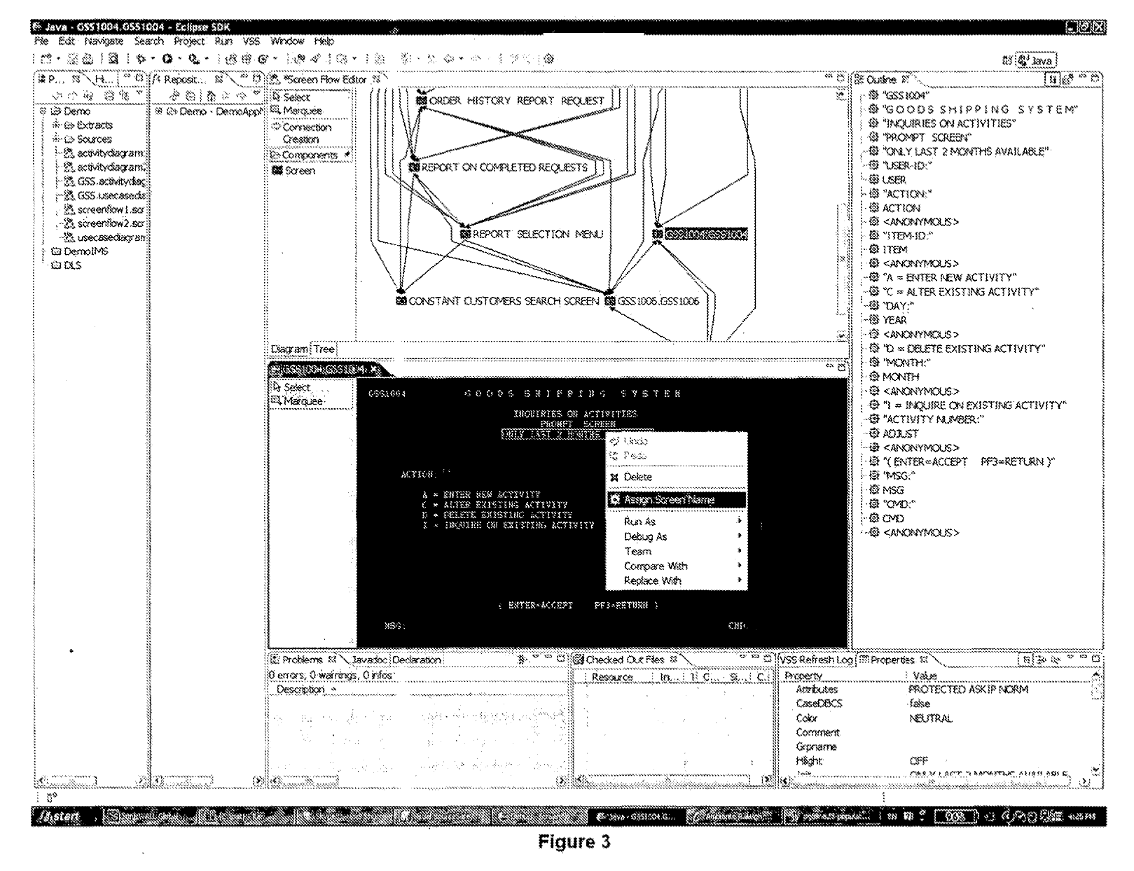

As shown in FIG. 3, initially, the user gives significant business names to all screens, programs, files or tables. This is necessary because application code uses only technical names while UML diagrams use business names. The assignment of business names may be done by displaying a list of all objects of the application, group to screens, programs, table, etc. When a user clicks on one of the legacy objects, it is displayed. As shown in FIG. 3, based on display of the object, the user has enough understanding to give it a business name and it is stored by the system.

In implementing the system and method, when a UML object is derived from an application artifact, the system stores and maintains a pointer to the corresponding this artifact. This allows the system user to explore derived UML diagrams and with a simple click, automatically open a window which shows the legacy objects corresponding to a UML object and even see appropriate code inside a program. This allows the user to view not only the derived diagrams and objects, but where and how they are implemented in the legacy application.

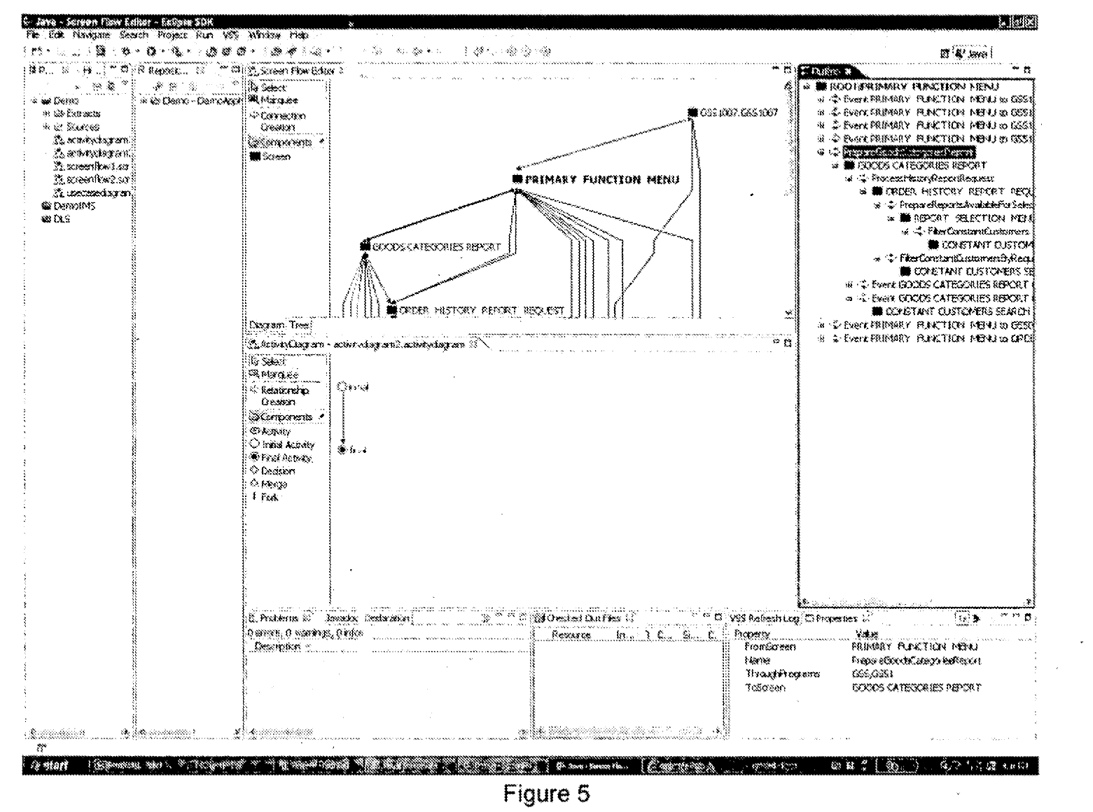

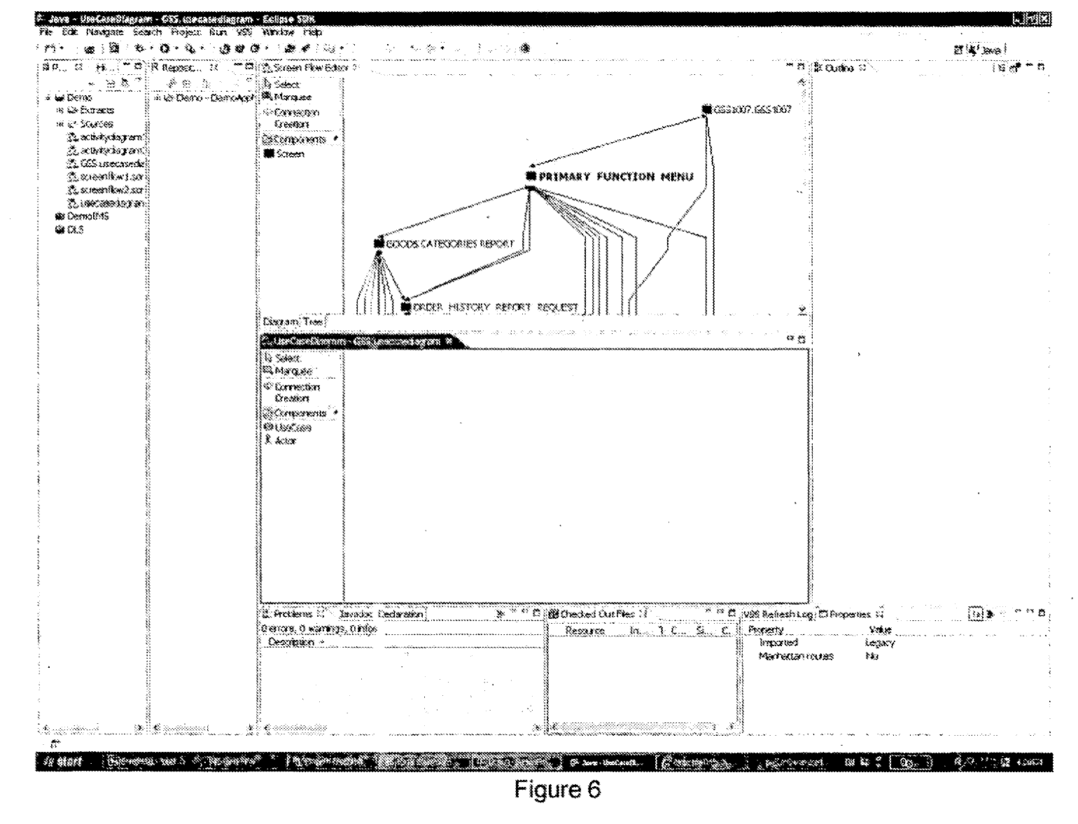

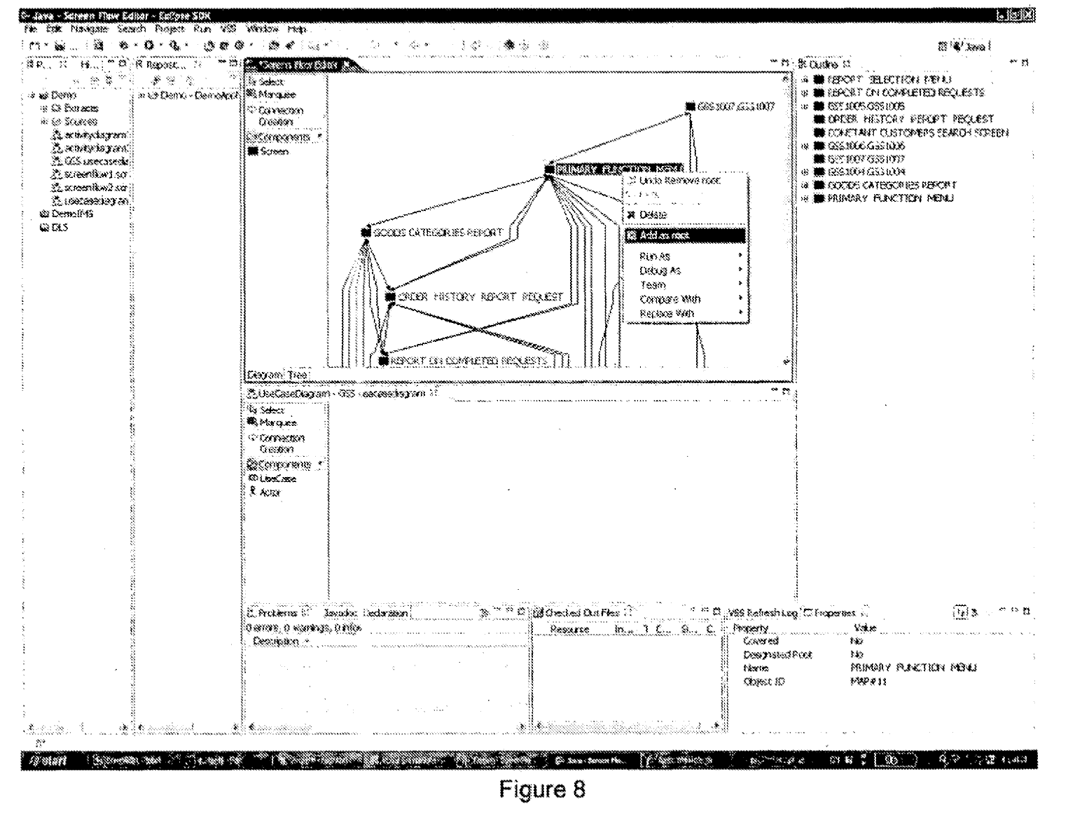

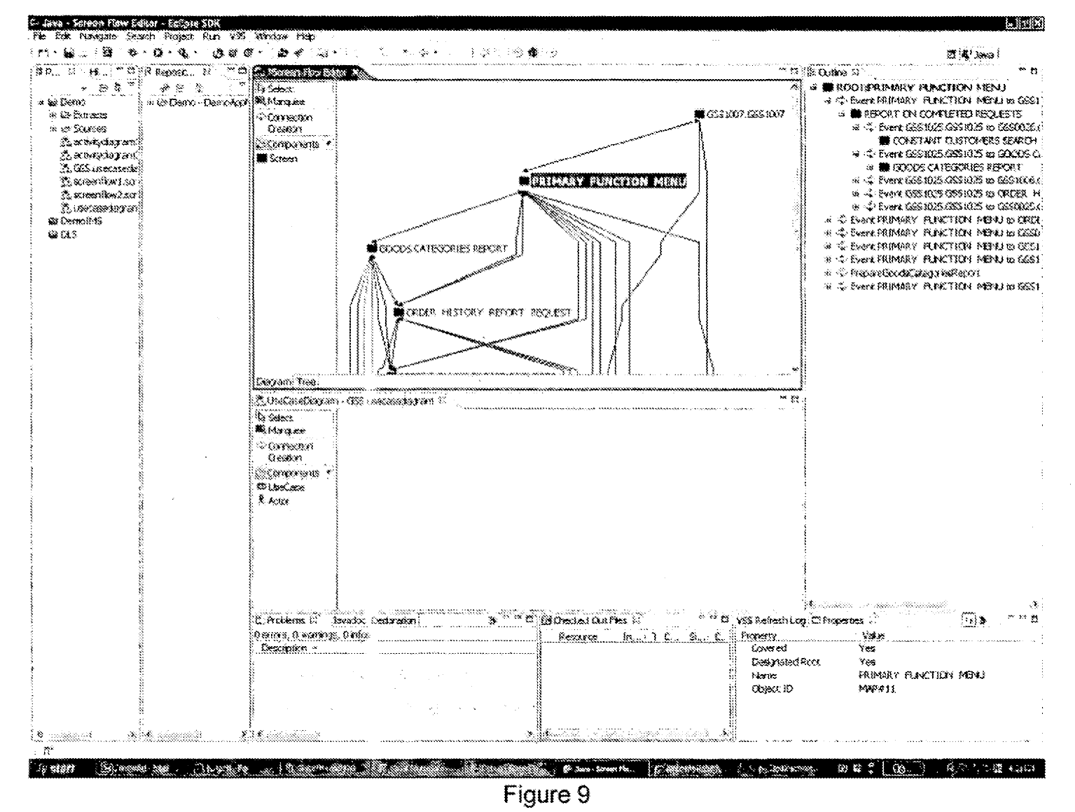

To extract a Use Case diagram, the user starts by creating a new and empty Use Case diagram, as shown in FIG. 6. The user also opens a window in which an inventory of all screens in the application is shown. A user then designates as the “root screen,” as in FIG. 8, which is the first screen encountered by the user of the application when entering the application. Information from the repository is then used to calculate all the screens to which the user of application may transition from the root screen. This step is repeated for each screen reached forming a tree with the root in the root screen as shown in FIG. 5. If not all screens in the application are reached, the remaining unreached screens are grouped in an unassigned set from which the user may again designate a root screen. This will result in at least one if not multiple trees which are presented graphically in a window defined as a “screen hierarchy,” as shown in FIG. 9.

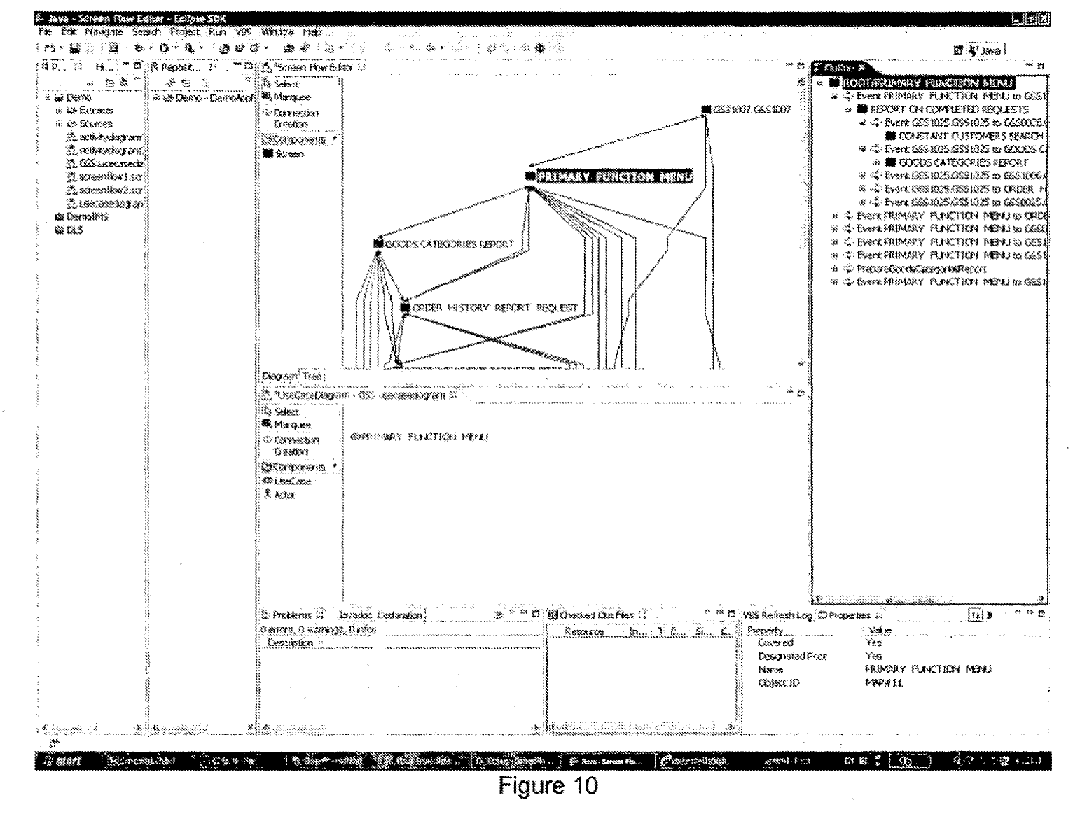

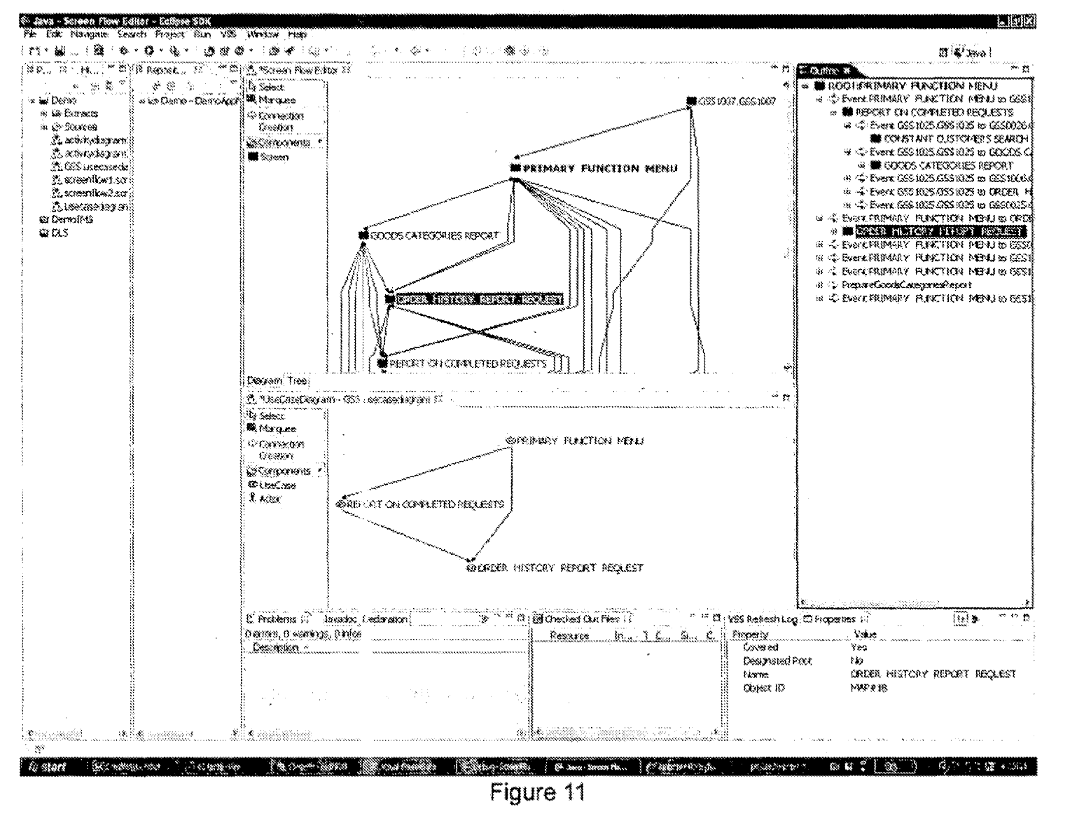

The user then picks a screen from the screen hierarchy and indicates that a use case is to be created from it. This is done by either dragging the screen object from the screen hierarchy window and dropping it in the Use Case diagram window, or from a pop up menu shown when the user right clicks on a screen. A use case object automatically appears having the same name as the business name of the screen as shown in FIG. 10. This action may repeat multiple times, thus creating multiple use cases. If there is a transition from screen A to screen B, then the Use Case from B appears as included in the Use Case from A or extending the Use Case from A as shown in FIG. 11. The choice of “included or extending” could be made by the user of the system. After all Use Cases desired are included in the diagram, the user of the system may further specify attributes, using a Properties window, which appears when the users clicks on a use case object. The user may also add “Actors” indicating what external agents act on each use case.

To extract an Activity diagram, the user starts by creating a new Activity diagram. Initially, this diagrams contains just the “initial” and “final” objects, as shown in FIG. 5. The user also opens a “screen flow” diagram which contains all the screens of the applications and events on the screens, i.e., actions or choices, which lead from one screen to another as also shown in FIG. 5. Thus, if on a screen A the user of the application presses PF5 to go to screen B, then the diagram shows a node for screen A connected to a node for event PF5, connected to a node to screen B as shown in FIG. 5. The user may give significant names to these events, overriding the names assigned automatically by the tool.

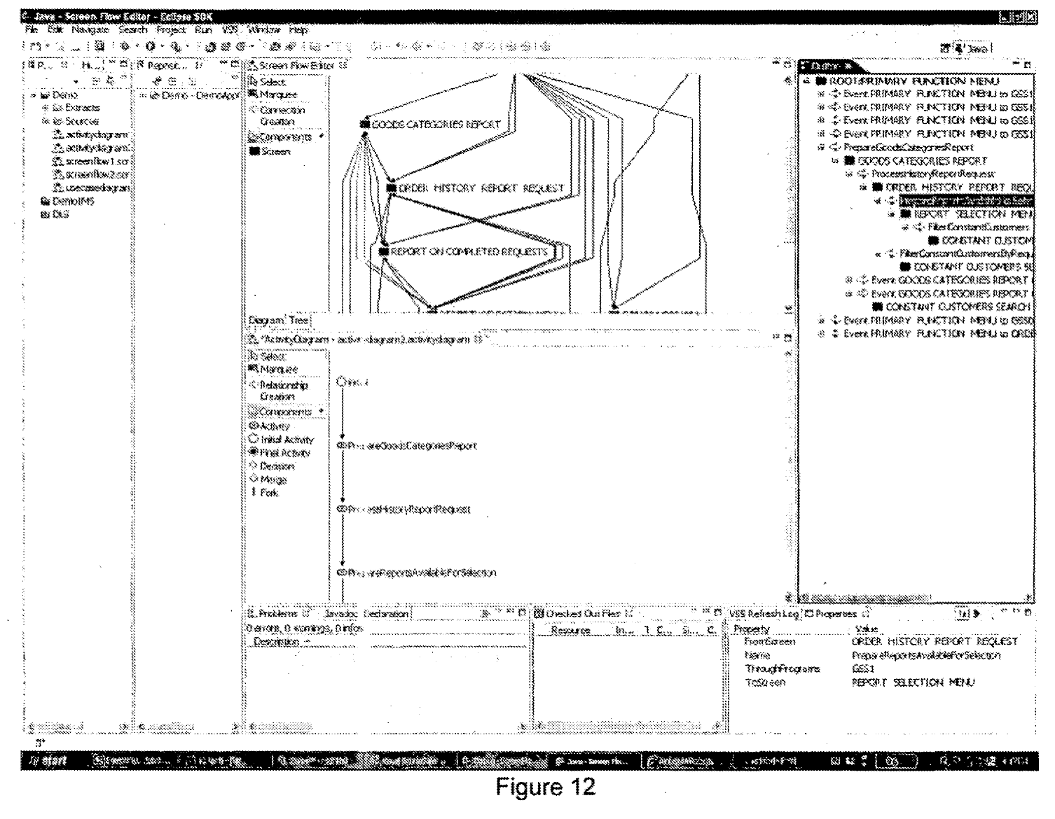

By way of example, a screen diagram may be constructed automatically as follows. If a screen A is received by a program A, which then passes exclusive control to program B when an event E is intercepted, and program B sends screen B, then the nodes “screen A”-“event E” screen B″ are automatically constructed as shown in FIG. 5. The user of the system clicks on a series of events in the screen flow diagram, designating a flow through the screens. For each event selected (either by drag and drop or by other methods) the system will create an activity object in the activity diagram, corresponding to that event, and initially having the same name as the event. Alternatively, in another implementation, the system may create two interconnected activities for each event, one representing the user action, and the other representing a system response. Thus from an event E, in the activity diagram will be constructed activity “user request E” and “application response to E.” More particularly, as may be appreciated, the activities in the Activity diagram will appear in the same order as the order in which the application user triggers a series of events to navigate from screen to screen in the application, as shown in FIG. 12. If the user of the application can navigate through the screens on two separate paths, the branching between these paths will appear in the Activity diagram as a decision point.

Once all UML objects and diagrams are derived, the business rules which were also separately identified in the application may be connected to the UML objects either automatically or manually. As each derived UML object has a pointer to the code showing the program code where it is implemented and each business rule has a pointer to the code showing where the rule is implemented, the system may connect the business rule to the UML object if the code pointed by the business rule intersects the code pointed by the UML object. Thus, the system user may see which business rules are applied in the performance of a particular activity.

Based on the foregoing description it will be apparent to one of ordinary skill how to program a system such as a computer to result in the methodology described as implemented through the screen shots illustrated herein. In addition, having thus generally described the invention, the same will become better understood from the appended claims from in which it is described in a non-limiting manner.

1. A method comprising:
accessing a created repository comprising objects and information about said objects which are contained in a legacy application;
creating a Unified Modeling Language (UML) model of the legacy application by processing said repository;
linking UML objects in the UML model to business rules and identifying additional details about the UML objects; and
creating an enhanced UML model of the legacy application from said linking of UML objects and from said identified details thereof.

2. The method of claim 1, wherein said creating of an enhanced UML model comprises creating said UML model as UML diagrams comprised of at least one of Use Case diagrams, Activity diagrams.

3. The method of claim 2, wherein;
the Use Case diagrams are created from a hierarchy of screens of the legacy application;
the Activity diagrams are created based on a flow of screens and procedures of the legacy application.

4. The method of claim 3, wherein said hierarchy of screens comprises a tree format starting with a main menu screen and subsequent flows to other screens, and where said Use Cases are designated by pointing to selected screens and creating a Use Case for each selected screen in a manner in which, if a selected screen is subordinate to a selected screen, then its Use Case extends or is included in the Use Case derived from the screen to which it is subordinate.

5. The method of claim 2, wherein said UML diagrams are populated with UML objects derived from the legacy application and can be manually modified to describe additional information not automatically extracted with said UML mining tool and also populated with additional UML objects manually created.

6. The method of claim 2, wherein said UML diagrams and UML objects are created in a manner in which they can be exported to and imported from another UML tool through XMI.

7. The method of claim 1, further comprising attaching business rules extracted from the legacy program to the UML model created with a UML mining tool to result in said enhanced UML model.

8. A method of extracting a Unified Modeling Language (UML) model from a repository describing a legacy application containing information about the artifacts and business rules which are contained in a legacy application, comprising:
creating a UML model of the legacy application by processing said repository;
linking UML objects in the UML model to business rules and identifying additional details about the UML objects; and
creating an enhanced UML model of the legacy application from said linking of UML objects and from said identified details thereof.

9. The method of claim 8, wherein said creating of an enhanced UML model comprises creating said UML model as UML diagrams comprised of at least of Use Case diagrams and Activity diagrams.

10. The method of claim 9, wherein;
the Use Case diagrams are created from a hierarchy of screens of the legacy application;
the Activity diagrams are created based on a flow of screens of the legacy application.

11. The method of claim 10, wherein said hierarchy of screens comprises a tree format starting with a main menu screen and subsequent flows to other screens, and where said Use Cases are designated by pointing to selected screens and creating a Use Case for each selected screen in a manner in which, if a selected screen is subordinate to a selected screen, then its derived Use Case extends or is included in the Use Case derived from the screen to which it is subordinate.

12. The method of claim 9, wherein said UML diagrams are populated with UML objects derived from the legacy application that can be manually modified to describe additional information not automatically extracted with said UML mining tool and by UML objects manually defined by the user.

13. The method of claim 9, wherein said UML diagrams and UML objects are created in a manner in which they can be exported to and imported from another UML tool through XMI.

14. The method of claim 8, further comprising attaching business rules extracted from the legacy application to the UML objects created with the UML mining tool to result in said enhanced UML model.

15. A computer program product for extracting a Unified Modeling Language (UML) model from a legacy application, comprising:
storage media for having a computer program product encoded thereon;
means for accessing a repository of all objects and information about said objects which are contained in a legacy application being operated on by the computer program product;
means for creating a UML model of the legacy application by processing said repository; and
means for linking UML objects in the UML model to business rules and specifying additional details about the UML objects, comprising at least information about the legacy objects from which they were derived to hereby create an enhanced UML model.

16. The computer program product of claim 15, further configured for creating the UML model as UML diagrams comprised of at least one of Use Case diagrams and Activity diagrams.

17. The computer program product of claim 16, wherein the product is configured for;
the Use Case diagrams being created from a hierarchy of screens of the legacy application;
the Activity diagrams being created based on a flow of screens of the legacy application.

18. The computer program product of claim 17, wherein said product is configured for having the hierarchy of screens comprise a tree format starting with a main menu screen and subsequent flows to other screens, and where said Use Cases are designated by pointing to selected screens and creating a Use Case for each selected screen in a manner in which, if a selected screen is subordinate to a selected screen, then its Use Case extends or is included in the Use Case derived from the screen to which it is subordinate.

19. The computer program product of claim 16, wherein said product is configured for having UML diagrams populated with UML objects derived from the legacy application that can be manually modified to describe additional information not automatically extracted with said UML mining tool and also populated with other objects manually created by the user.

20. The computer program product of claim 15, wherein said product is configured for having the UML diagrams and UML objects created in a manner in which they can be exported to and imported from another UML tool through XMI.

21. The computer program product of claim 15, wherein said product is further configured for attaching business rules extracted from the legacy application to the created UML model to result in said enhanced UML model.
